(19) United States
(12) Patent Application Publication
(10) Pub. No.: US 2003/0195880 A1
(43) Pub. Date: Oct. 16, 2003

(54) Method and system for providing a graphical interface to a database

(76) Inventor: Renato L. Mancinelli, Richboro, PA (US)

Correspondence Address: SAWYER LAW GROUP, P.O. Box 51418, Palo Alto, CA, 94303, US

(21) Appl. No.: 10/405,574

(22) Filed: Apr. 1, 2003

Related U.S. Application Data
(63) Continuation-in-part of application No. 09/478,622, filed on Jan. 5, 2000.

(51) Int. Cl. G06F 17/30

(52) U.S. Cl. 707/4

(57) ABSTRACT

A method and system for providing a graphical interface to a database includes: providing a plurality of graphical user interface (GUI) items for retrieving information concerning database objects of the database; receiving a selection of one of the plurality of GUI items from a user; building a Structured Query Language (SQL) query for retrieving the information, where the building is performed transparently to the user, such that the user is not required to have knowledge of a catalog of the database; and executing the SQL query against the catalog, where the executing is performed transparently to the user. The user need not have a thorough understanding of SQL to retrieve information concerning database objects of the database. SQL queries need not be entered or re-entered manually. The performance of SQL queries may be as easy or as complicated as the user desires.

### CROSS-REFERENCE TO RELATED APPLICATIONS

This application is a Continuation-In-Part of co-pending U.S. patent application, titled “Method and System for Providing a Graphical Interface to a Database”, Ser. No. 09/478,622, filed on Jan. 5, 2000.

### FIELD OF THE INVENTION

The present invention relates to databases, and more specifically to an interface to databases.

### BACKGROUND OF THE INVENTION

Database and database structures are well known in the art. One type of database includes that developed by ORACLE CORPORATION. FIG. 1 is a simple block diagram illustrating a network with an Oracle database. In this network 100, a user 102 interfaces with the Oracle database 104 via a network connection 106 through software 108 on a workstation 110. Conventionally, the software 108 executes in a UNIX environment.

In order to obtain information concerning database objects of the database 104, Structured Query Language (SQL) queries are executed. A user 102 must be familiar with SQL and Oracle database structures, as the SQL queries and scripts can be complicated. To build the SQL queries, the user 102 must also know the contents of the catalog 112 and how to access the catalog 112. However, this level of knowledge of SQL is often beyond the typical user 102. In this situation, database administrators need to hire consultants with expertise in Oracle database structure and SQL. Thus, database administrators are forced to expend resources to hire consultants and experts in order to maintain the integrity of their data. In addition, when the typical user 102 desires a report on data from the database 104, the user 102 must request the report from the database administrators, who then builds the SQL queries required to obtain the data. This results in inefficiency.

In addition, because the software 108 is executing in a UNIX environment, the SQL statements must be re-entered each time it is to be executed. When a statement needs to be re-executed at a certain time interval, the user 102 must remain at the workstation 110 and manually re-enter and re-execute the query each time. This is quite cumbersome, especially when the SQL query is complex, or when the user 102 does not have sufficient knowledge of SQL.

Once the SQL query is executed, the result can be viewed. However in the UNIX environment, the information is displayed very quickly. In order for the user to meaningfully view the information, a spooling command must be entered to cause the information to be dumped into a file, the SQL query must be re-executed, and the file must then be accessed. However, the dump file is typically in simple text with no formatting and is difficult to read. Therefore, the user 102 must expend the time and energy to format the information in the dump file before it can be understood.

Before the user 102 can view the dump file, the user 102 must navigate through the UNIX file system. Such navigation is time-consuming. The user 102 must manually perform an FTP session to access the database and then navigate through the file system in search of the specific file. The navigation in the UNIX environment is not graphical. Once the file is found, it can be opened, but the information in the file must be formatted before it can be understood. Thus, for the above reasons, the conventional method and system of accessing an Oracle database is burdensome and inefficient.

Accordingly, there exists a need for a method and system for providing a graphical interface to a database. The method and system should allow a user without an expertise in SQL to interface with an Oracle database. The present invention addresses such a need.

### SUMMARY OF THE INVENTION

A method and system for providing a graphical interface to a database includes: providing a plurality of graphical user interface (GUI) items for retrieving information concerning database objects of the database; receiving a selection of one of the plurality of GUI items from a user; building a Structured Query Language (SQL) query for retrieving the information, where the building is performed transparently to the user, such that the user is not required to have knowledge of a catalog of the database; and executing the SQL query against the catalog, where the executing is performed transparently to the user. The user need not have a thorough understanding of SQL to retrieve information concerning database objects of the database. SQL queries need not be entered or re-entered manually. The performance of SQL queries may be as easy or as complicated as the user desires.

### BRIEF DESCRIPTION OF THE FIGURES

FIG. 1 is a simple block diagram illustrating a network with a Oracle database.

FIG. 2 is a simple block diagram illustrating a preferred embodiment of a network which provides a graphical interface to a database in accordance with the present invention.

FIG. 3 through 14C illustrate the features provided by the Oracle Assistant in accordance with the preferred embodiment of the method and system of the present invention.

FIG. 15 is a flow chart illustrating a preferred embodiment of a method for providing a graphical interface with databases in accordance with the present invention.

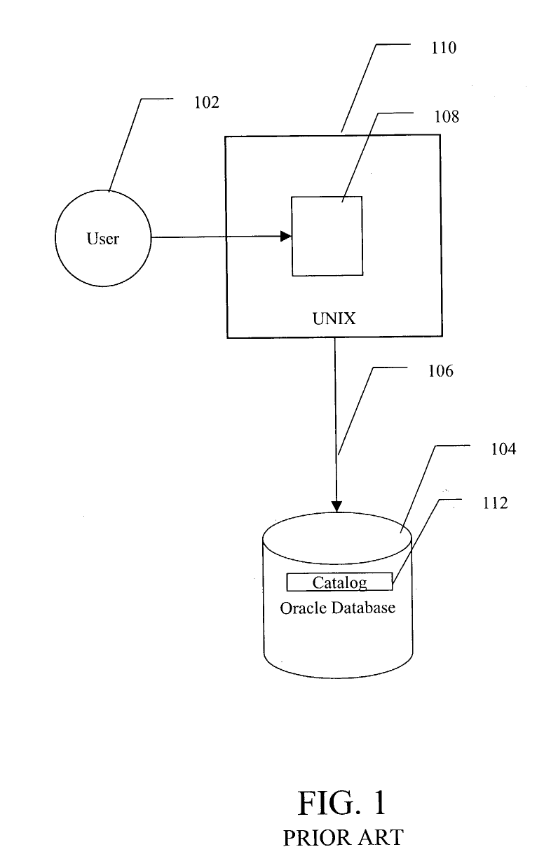

### DETAILED DESCRIPTION

The present invention provides a method and system for providing a graphical interface to a database. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

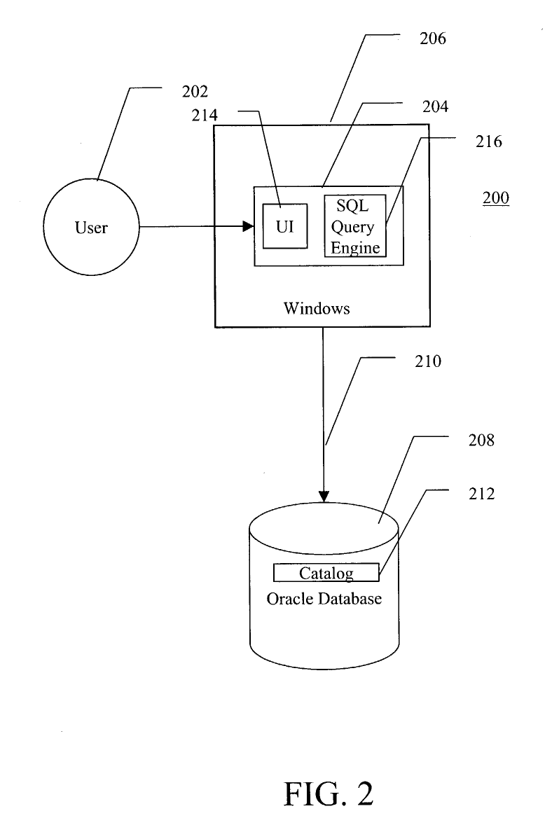

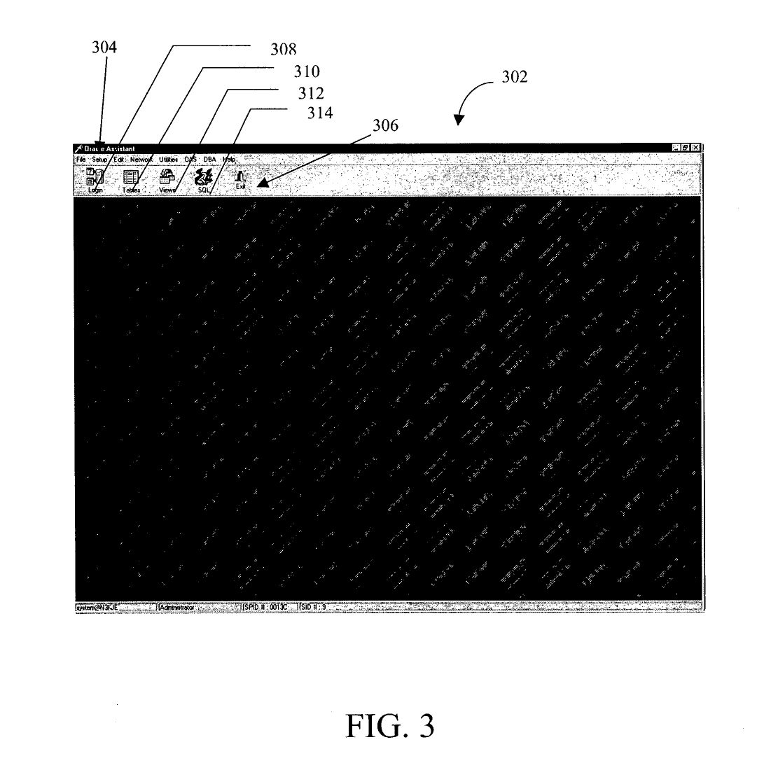

The method and system in accordance with the present invention provides the graphical interface to a database in a software, called an “Oracle Assistant”, which resides on a workstation. To more particularly describe the features of the present invention, please refer to FIGS. 2 through 15 in conjunction with the discussion below.

FIG. 2 is a simple block diagram illustrating a preferred embodiment of a network 200 which provides a graphical interface to a database in accordance with the present invention. The network 200 comprises an Oracle Assistant 204 (“OA”) on a workstation 206. The OA 204 executes in a windows environment and comprises a user interface (UI) 214 and a SQL query engine 216. A user 202 interfaces with the UI 214 to access the database 208 via a network connection 210. Through the UI 214, the user 202 is able to request information concerning database objects with limited knowledge of SQL, i.e., with limited knowledge of how to build SQL queries, and/or without knowing the contents of the catalog 212 or how to access the catalog 212. The UI 214 allows the user 202 to enter as much or as little information concerning the desired database objects as the user 202 knows. The SQL query engine 216 then builds the required SQL query or queries and executes the them against the catalog 212 to retrieve the desired information. These functions by the OA 204 are performed transparently to the user 202.

FIGS. 3 through 14C, and the accompanying text, illustrate the features provided by the OA 204 in accordance with the preferred embodiment of the method and system of the present invention.

FIG. 3 illustrates the window 302 which is displayed when the OA 204 is initiated. The display includes GUI items. “GUI items”, as used in this specification, refer to graphical images which assist in the performance of a task and with which users may interact. Examples of GUI items comprise a window 302, a menu 304, and quick access buttons 306. The quick access buttons 306 comprise a Logic button 308, a Tables button 310, a Views button 312, and a SQL button 314. Other examples of GUI items include tabs, check boxes, entry boxes, icons, panels, and grids. In the preferred embodiment the user 202 may retrieve information concerning database objects by selects the appropriate GUI item in the menu 304 or a quick access button 306. The GUI item may be selected with a mouseclick. For example, the user 202 may click on the Login button 308 to initiate access to the database 208.

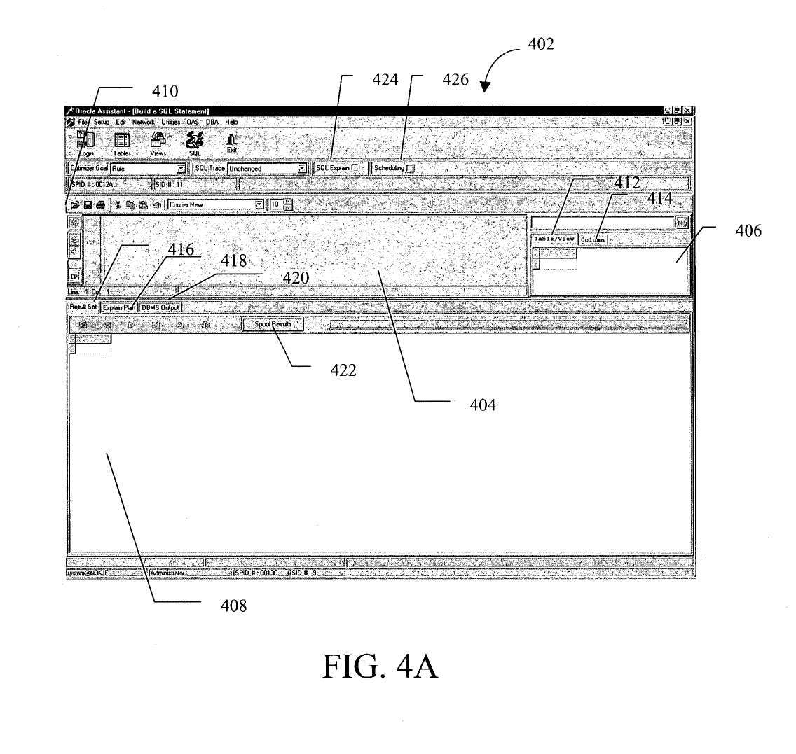

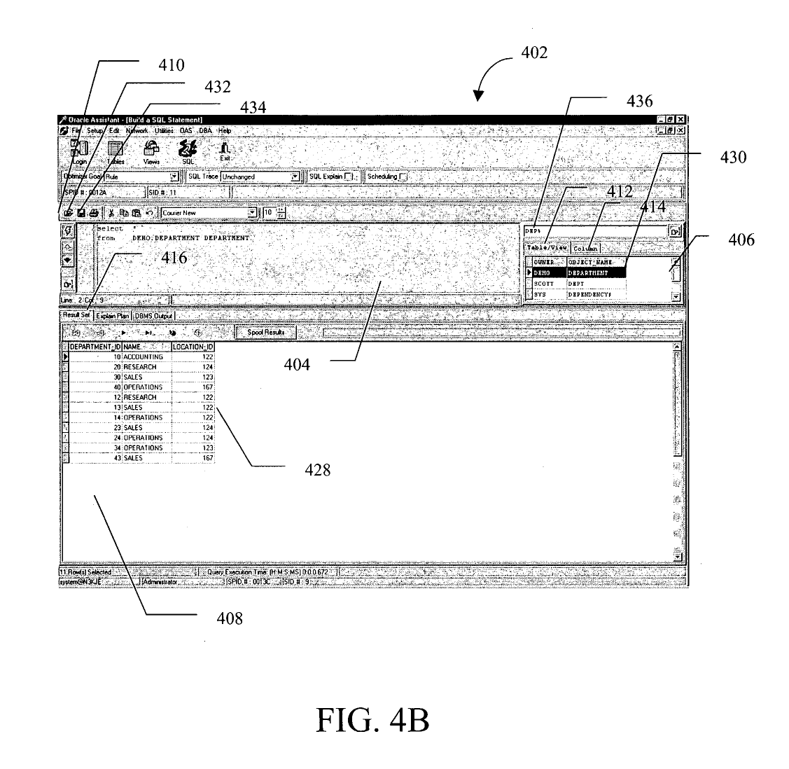

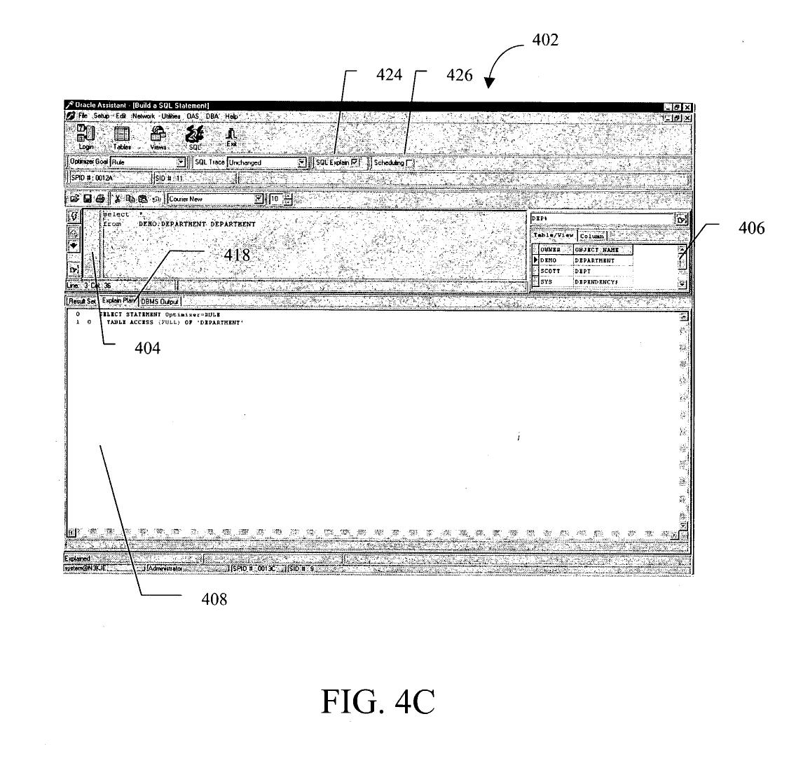

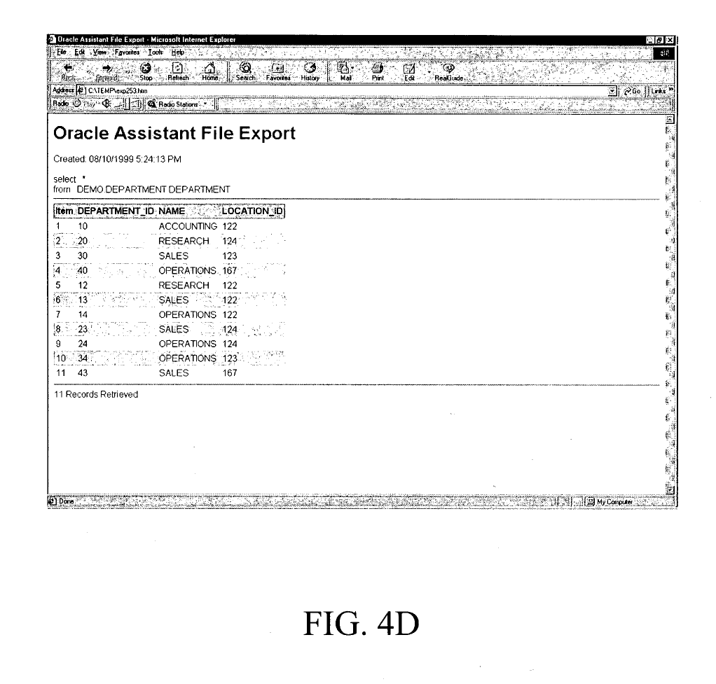

FIGS. 4A-4D illustrate the features provided by the OA 204 when the user 202 selects the SQL button 314. FIG. 4A illustrate the window 402 which is displayed when the user 202 selects the SQL button 314. The workspace in the window, called the canvas, is divided into three panels: a first panel 404 used for inserting a SQL query if the user 202 can and wishes to do so, a second panel 406 for retrieving table/view names and their corresponding columns, and a third panel 408 for displaying the results, explain plan, and messages from the database 208 in the execution of the SQL query in the first panel 404. Above the first panel 404 is a bar 410 with a variety of buttons with icons. In the second panel 406 are two tabs, a Table/View tab 412 and a Column tab 414. In the third panel 408 are three tabs, a Result Set tab 416, an Explain Plan tab 418, and a Database Management System (DBMS) Output tab 420. The third panel 408 also has a Spool Results button 422. The window 402 also includes other GUI items, including a SQL Explain check box 424 and a Scheduling check box 426.

FIG. 4B illustrates the window 402 with an issued SQL query. The results are displayed in the third panel 408 in a grid object 428 when the Result Set tab 416 is selected. The user 202 can navigate around the grid object 428, from top to bottom and left to right. The user 202 can enter in the field 436 as little or as much information concerning the database object as the user 202 knows. For example, the user 202 can enter “DEP %” to indicate that the desired object's name begins with “DEP”. The SQL query engine 216 then builds a SQL query to retrieve all table or view names beginning with “DEP”, and executes this SQL query against the catalog 212. The result is displayed in the panel 406. The building of the SQL query and the execution of it against the catalog 212 are performed transparently to the user 202. The user 202 can then select the object name of interest, for example by double-clicking on the “Demo.Department” entry 430 in the panel 406. By double clicking on the “Demo.Department” entry 430, the “from” clause in the panel 404 is generated. By selecting the “Column” tab 414, the SQL query engine 216 builds the SQL queries to retrieve all of the columns in the table “Demo.Department” and executes them against the catalog 212. The result would then be displayed in the panel 406. The building of these SQL queries and the execution of them against the catalog 212 are also performed transparently to the user 202.

The bar 410 above the first panel 404 contains various buttons, including a button 432 with an icon of a folder and a button 434 with an icon of a floppy disk. The user 202 may select button 434 to store the content of the panels 404-408 and button 432 to populate the panels 404-408 with a previously saved script.

FIG. 4C illustrates the window 402 when the SQL Explain check box 424 is checked by the user 202. When check box 424 is checked, the OA 204 computes the explain plan of the SQL query in the first panel 404. The explain plan would be used to determine how efficiently the query has been written. The explain plan is displayed in the third panel 408 with the selection of the Explain Plan tab 418. If the user 202 also checks the Scheduling check box 426, then the OA 204 would prompt the user 202 for a time interval. Upon receiving a time interval value from the user 202, the OA 204 would re-execute the SQL query in the first panel 404 once at each time interval. Any messages from the database 208 created in the execution of the SQL query is displayed under the DBMS Output tab 420 (FIG. 4A). This greatly improves on the conventional interfaces where the user 202 would be required to manually re-enter the SQL query each time it is to be re-executed.

FIG. 4D illustrates the window 402 when the Spool Results button 422 (FIG. 4A) is selected. Upon the selection of the Spool Results button 422, the OA 204 will prompt the user 202 for a desired file format with a list of file formats, e.g., HTML, spreadsheet format, word processor format, etc. Once the user 202 selects the desired file format, the results are exported to the selected format. For example, FIG. 4D illustrates the window 402 when the HTML format is selected. This improves on conventional interfaces where the user 202 must manually perform each of these steps. The OA 204 automatically performs them for the user 202.

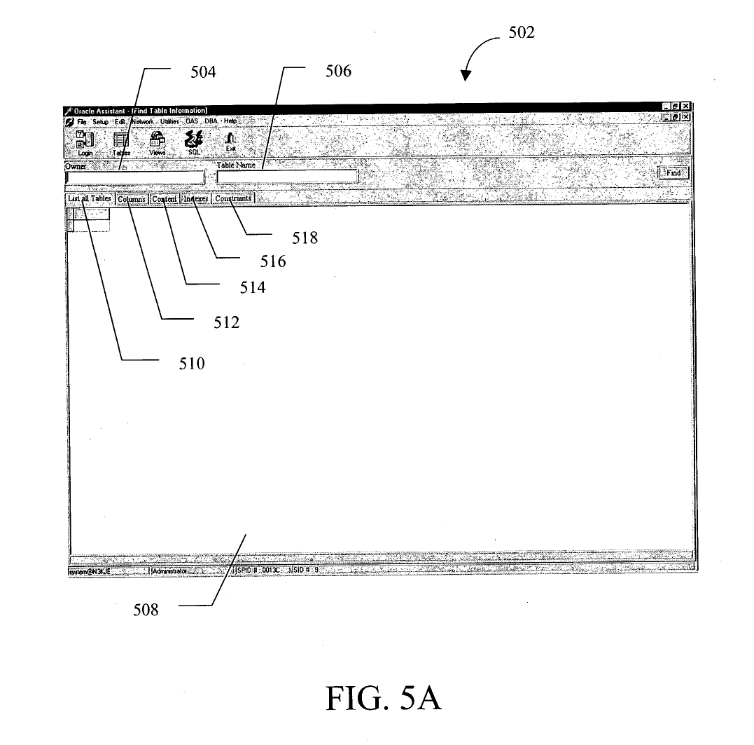

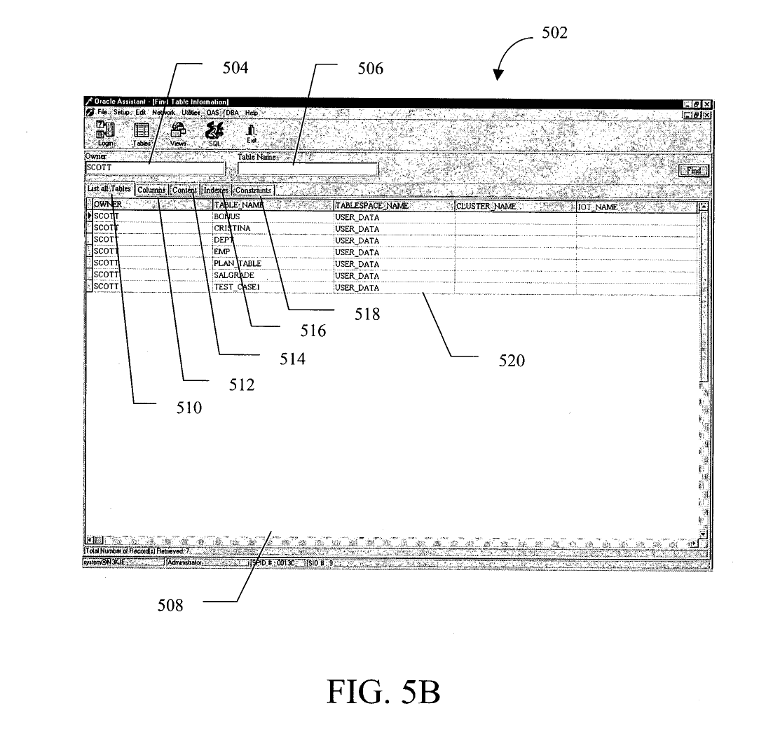

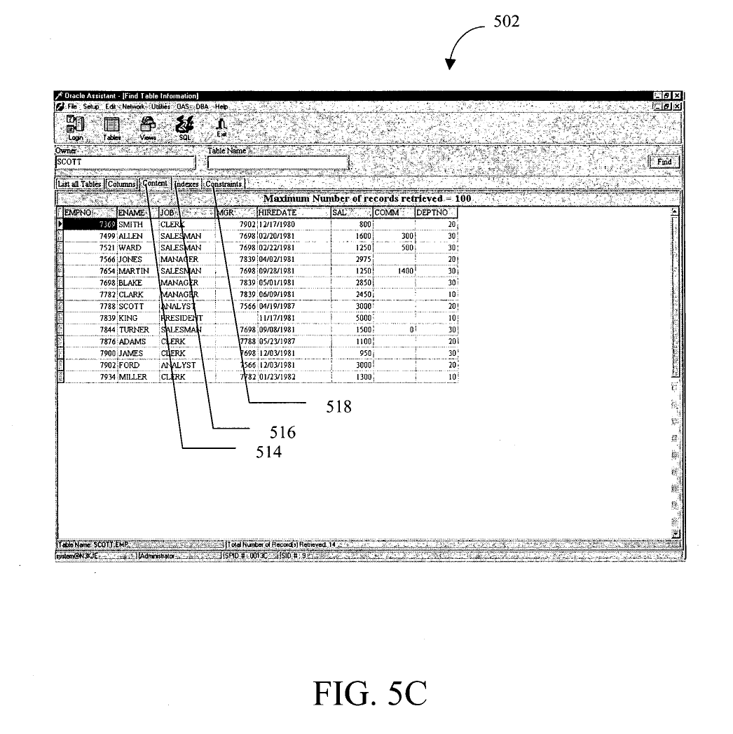

FIGS. 5A-5C illustrate the features provided by the OA 204 when the user 202 selects the Tables button 308. FIG. 5A illustrates a window 502 which is displayed when the Tables button 308 is selected. The window 502 includes GUI items comprising an Owner entry box 504, a Table Name entry box 506, and a panel 508. The panel 508 includes five tabs: List All Tables tab 510, Columns tab 512, Content tab 514, Indexes tab 516, and Constraints tab 518. The user 202 has the option of entering as much or as little information as the user 202 knows about a table owner name in the Owner entry box 504 and/or a table name in the Table Name entry box 506. Wild card characters are allowed. The SQL query engine 216 then builds the SQL queries required to retrieve the table owner name and executes these queries against the catalog 212, transparently to the user 202. The results are then displayed in the panel 508.

FIG. 5B illustrates an example display of the window 502. In this example, a table owner, “SCOTT”, was entered in the Owner entry box 504. The results containing all tables owned by Scott are displayed in a grid 520 in the panel 508. The user 202 may then access information under the remaining tabs 512-518 by selecting one of the tables in the grid 520. For example, the user 202 may select the “EMP” table. The SQL query engine 216 then build and executes the SQL queries for retrieving the contents of the “EMP” table against the catalog 216, transparently to the user 202. The results are then displayed.

FIG. 5C illustrates the display when the “EMP” table is selected. The contents of the “EMP” table are displayed when the user 202 selects the Content tab 514. In the preferred embodiment, only 100 records are retrieved. This is to provide the user 202 with an idea of the type of information stored in the selected table while also minimizing network traffic. The user 202 may retrieve more records for a given table by entering a query in the first panel 404 (FIG. 4A). When the user 202 selects the Indexes tab 516 or the Constraints tab 518, the index and referential constraints information, respectively, for the selected table is displayed.

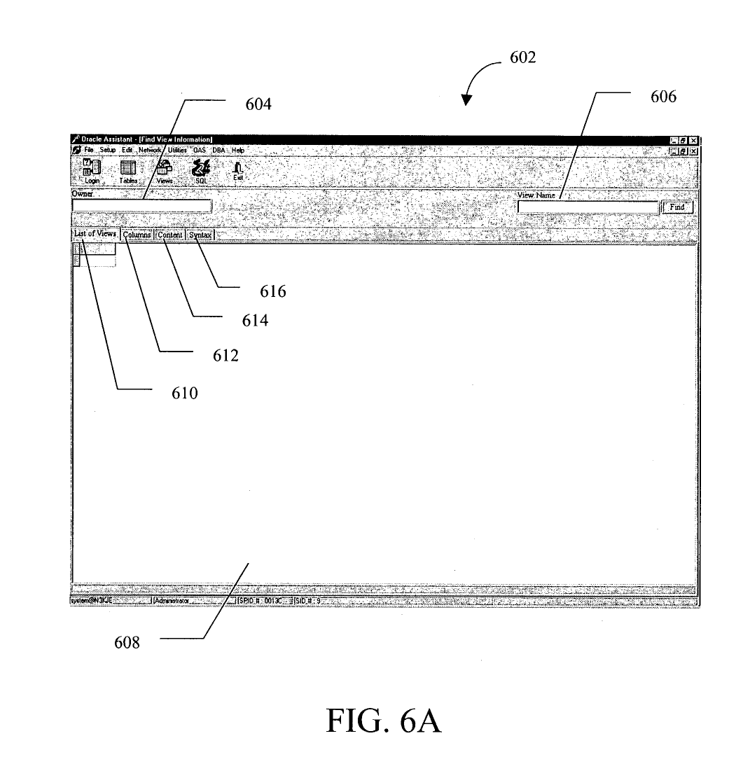

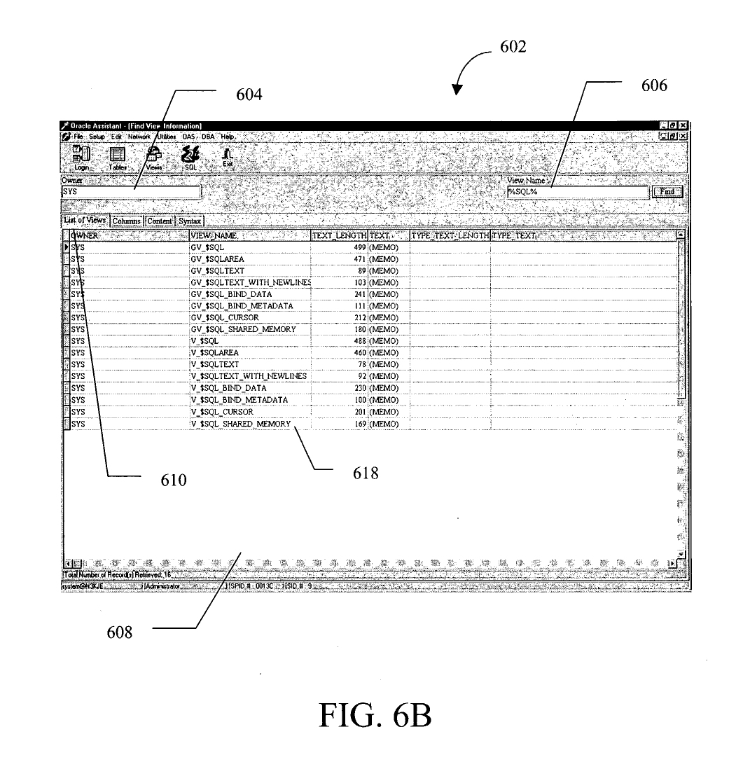

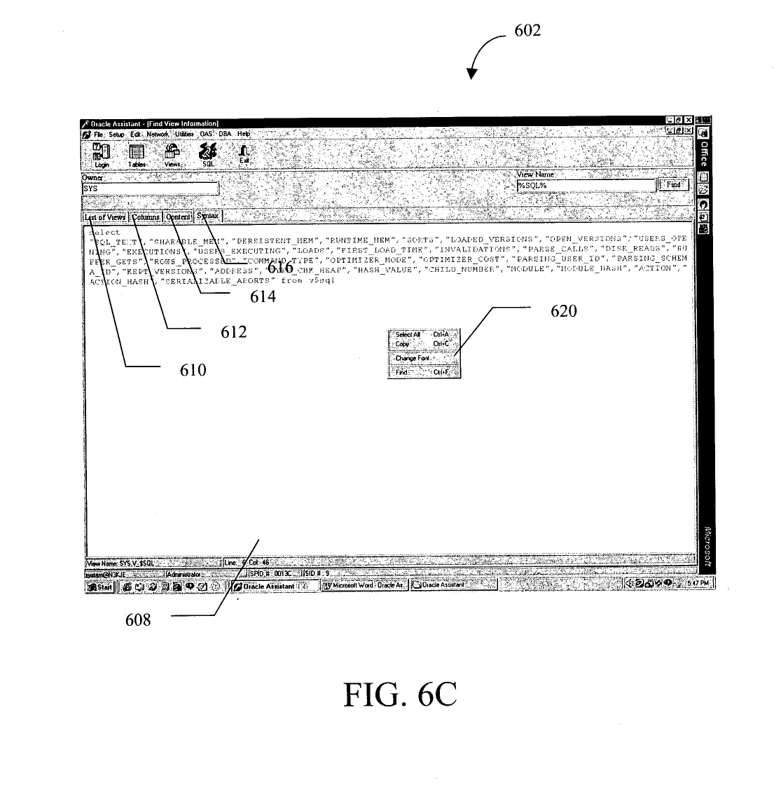

FIGS. 6A-6C illustrate the features provided by the OA 204 when the user 202 selects the Views button 312. FIG. 6A illustrates a window 602 which is displayed when the Views button 312 is selected. The window 602 includes GUI items comprising an Owner entry box 604, a View Name entry box 606, and a panel 608. The panel 608 includes four tabs: List of Views tab 610, Columns tab 612, Content tab 614, and Syntax tab 616. The user 202 has the option of entering as much or as little information as the user 202 knows about a view owner name in the Owner entry box 604 and/or a view name in the View Name entry box 606. Wild card characters are allowed. The SQL query engine 216 then builds and executes the SQL queries required to retrieve the view owner name and against the catalog 212, transparently to the user 202. The results are then displayed in the panel 608.

FIG. 6B illustrates an example display of the window 602. In this example, a view owner “SYS” was entered in the Owner entry box 604, and a view name of “SQL” was enter in the View Name entry box 606. The results containing all views owned by Sys with a name containing the word “SQL” are displayed in a grid 618 in the panel 608. The user 202 may select one of the views displayed in the grid 618. The SQL query engine 216 then builds and executes the SQL queries required to retrieve the columns and contents of the selected view against the catalog 212, transparently to the user 202. By selecting the Column tab 612 or the Content tab 614, the user 202 may view the columns and contents, respectively, of the selected view.

FIG. 6C illustrates the display of the syntax of the selected view in window 602. When the user 202 selects the Syntax tab 616, the syntax associated with the selected view is displayed in the panel 608. For example, if the user 202 selects the “V_$SQL” view (FIG. 6B), the syntax illustrated in panel 608 of FIG. 6C is displayed. In response to the user 202 “right-clicking” the mouse in the panel 608, a pop-up menu 620 is displayed. By selecting a GUI item in the menu 620, the user 202 can customize the appearance of the syntax text, import the text into another windows application, or look for any text within the syntax.

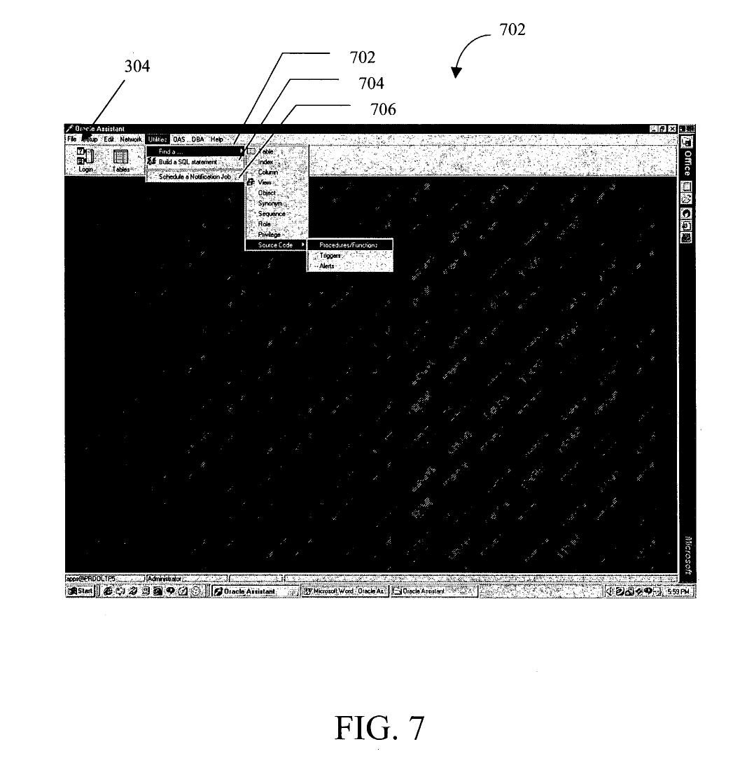

Information concerning database objects other than those described in FIG. 4A-6C may also be retrieved using the OA 204. For example, FIG. 7 illustrates other options for retrieving information concerning other database objects through the Utilities menu option of the menu 304. The user 202 may find information concerning particular database objects, such as a table, index, column, view, object, etc., by selecting the “Find a ..” menu option 702. The user 202 may build a SQL statement by selecting the Build a SQL Statement menu option 704. The user 202 may also schedule a notification job by selecting the Schedule a Notification Job menu option 706.

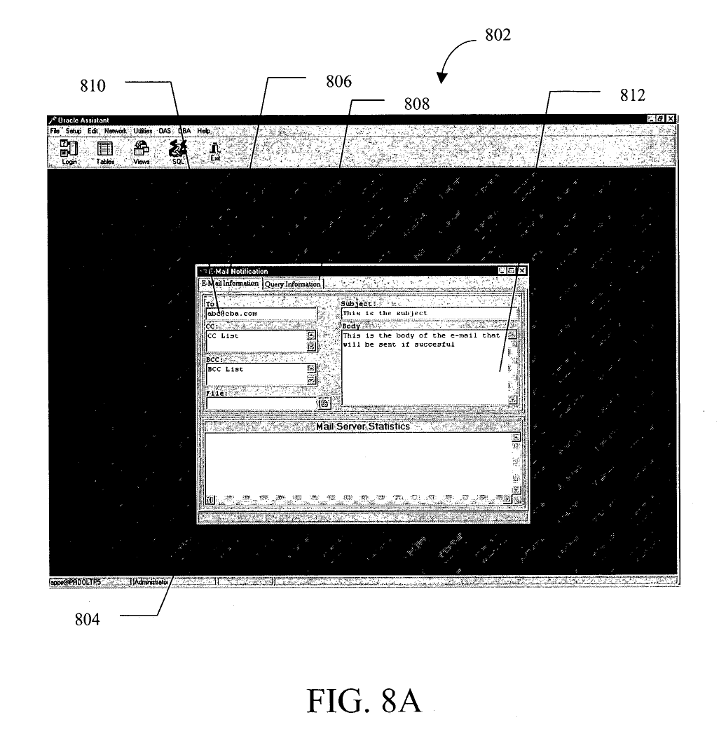

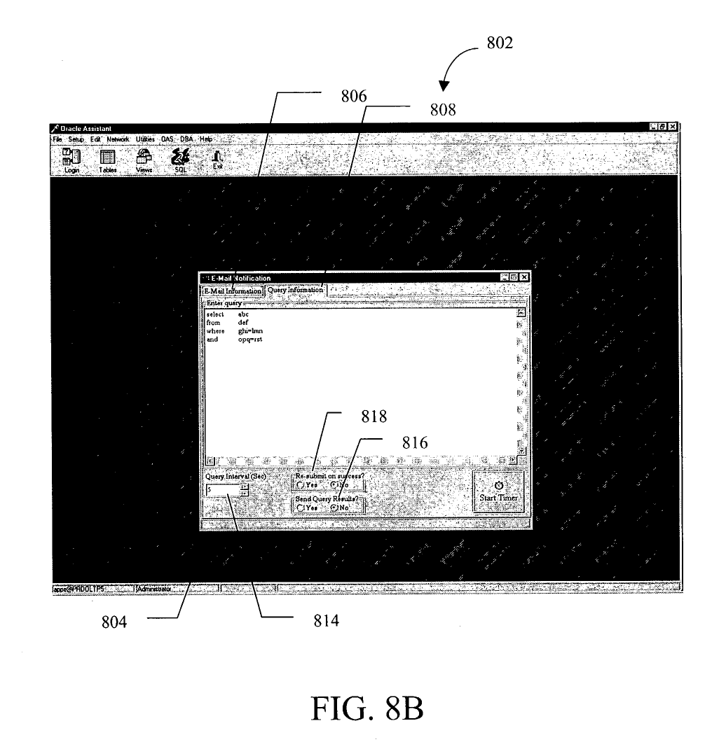

FIGS. 8A-8B illustrate the feature provided by the OA 204 when the user 202 selects the Schedule a Notification Job menu option 706. When the user 202 selects the Schedule a Notification Job menu option 706, an E-Mail Notification window 804 is displayed. The E-Mail Notification window 804 has two tabs, an E-Mail Information tab 806 and a Query Information tab 808. FIG. 8A illustrates the E-Mail Notification window 804 when the E-Mail Information tab 806 has been selected. The information in the E-Mail Information tab 806 pertains to the e-mail process. Typical e-mail information may then be provided by the user 202. For example, the e-mail address of the person to be notified is provided in the To entry box 810. The message to be e-mailed is provided in the Body entry box 812. A pager PIN number may also be provided in the To entry box 810 to sent a notification page to the addressee. Conventional interfaces do not have the notification feature described above.

FIG. 8B illustrates the display of the Query Information tab 808 of the E-Mail Notification window 804. The window 804 in this tab 808 contains the query to be executed and its frequency. If the query is to be re-executed, the time interval for the re-execution may be indicated in the Query Interval entry box 814. If and when the condition checked by the query is successful, then the e-mail notification is sent. By checking the desired options in the Re-submit on success check box 816 and the Send Query Results check box 818, the user 202 may also specify if the query should continue checking or if it should stop checking after the first occurrence.

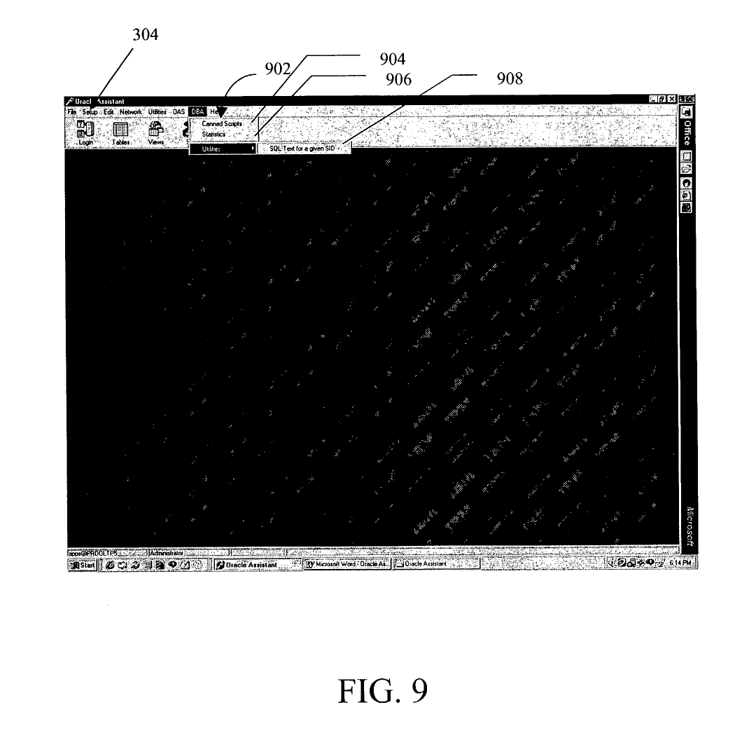

FIG. 9 illustrates the features available under the DBA menu option 902 of the menu 304. The user 202 may access canned scripts by selecting the Canned Scripts menu option 904, database statistics by selecting the Statistics menu option 906, and text for the SQL request for a given Station Identifier (SID) by selecting the SQL Text for a given SID menu option 908.

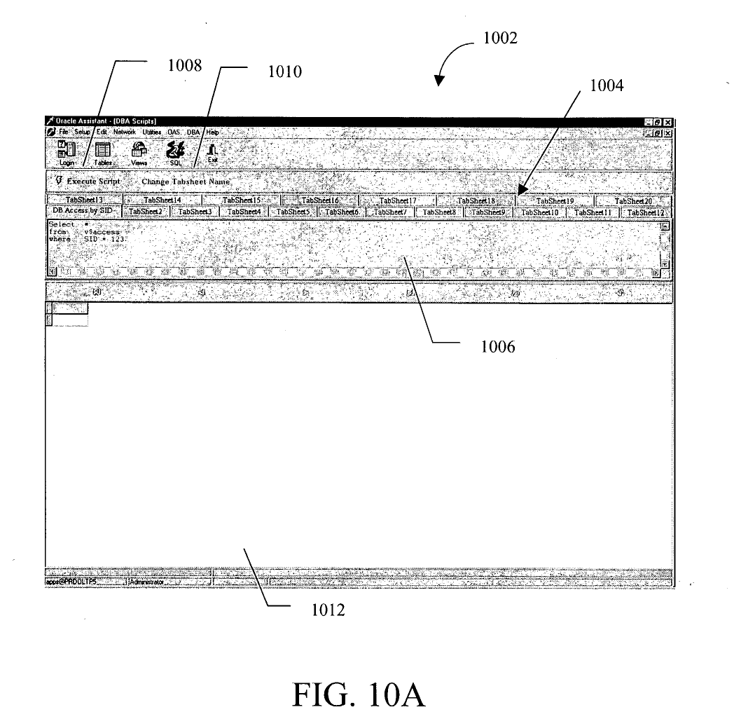

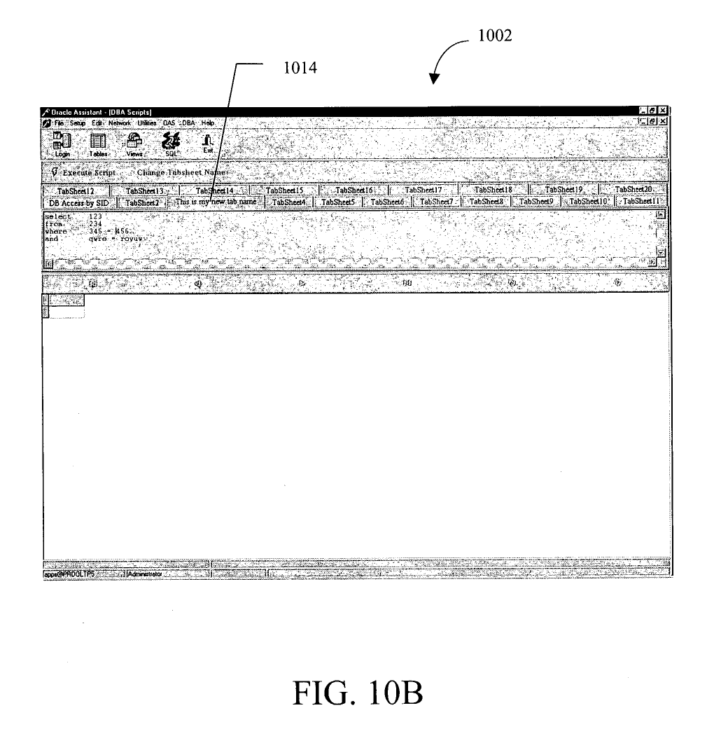

FIGS. 10A-10B illustrate the feature provided by the OA 204 when the user 202 selects the Canned Scripts menu option 904. When the user selects the Canned Scripts menu option 904, a window 1002 is displayed. The canned scripts allow the user 202 to store up to twenty pre-defined scripts. Conventionally, scripts must be saved in a file, which the user must manually find and access. But the OA 204 remembers these scripts and automatically retrieves and displays them every time the view is invoked. With this feature, the user 202 may quickly access the most commonly used scripts without the need to re-enter them. Each canned script is represented by one of the tabs 1004. The user 202 may assign an alias to each canned script and have that name displayed on the tabs 1004. The window 1002 also includes a first panel 1006 which displays the query. The window 1002 contains two buttons, an Execute Script button 1008 and a Change Tabsheet Name button 1010. The query displayed in the first panel 1006 is executed when the user 202 selects the Execute Script button 1008. The results would be displayed in the second panel 1012. When the user 202 wishes to change the alias of one of the scripts, the user 202 selects the Change Tabsheet name button 1010. FIG. 10B illustrates the window 1002 when the user 202 has selected the canned script under tab 1014. The tab name has been changed as well.

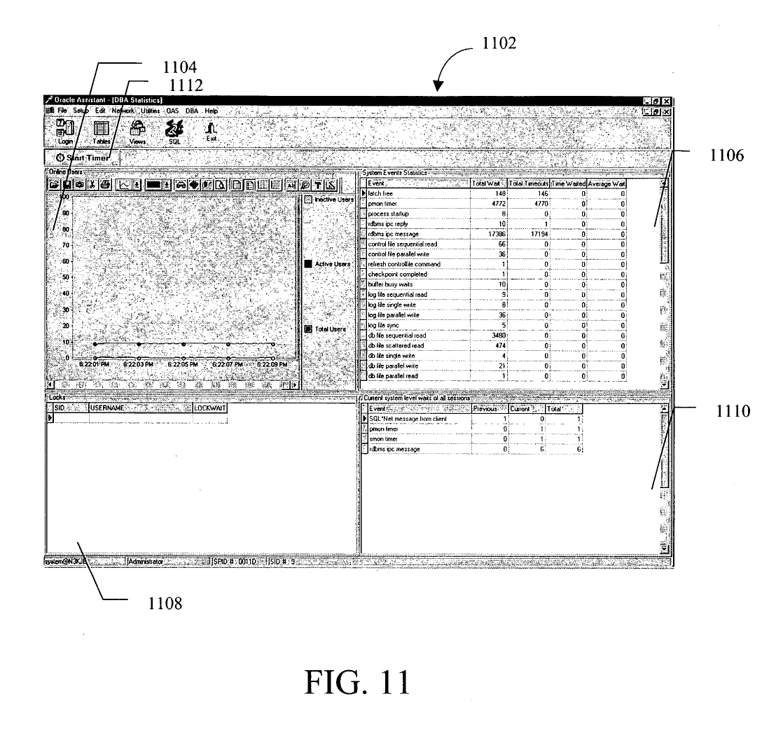

FIG. 11 illustrates the feature provided by the OA 204 when the user 202 selects the Statistics menu option 906. When the user 202 selects this menu option, the OA 204 retrieves database specific information by executing four queries to retrieve information concerning: online users, system events statistics, locks, and current system level waits of all sessions. The results are displayed in window 1102 in four different panels 1104-1110, respectively. If the Start Timer button 1112 is depressed, then the user 202 is prompted for a time interval. The OA 204 will re-execute the four queries according to the time interval and display the information.

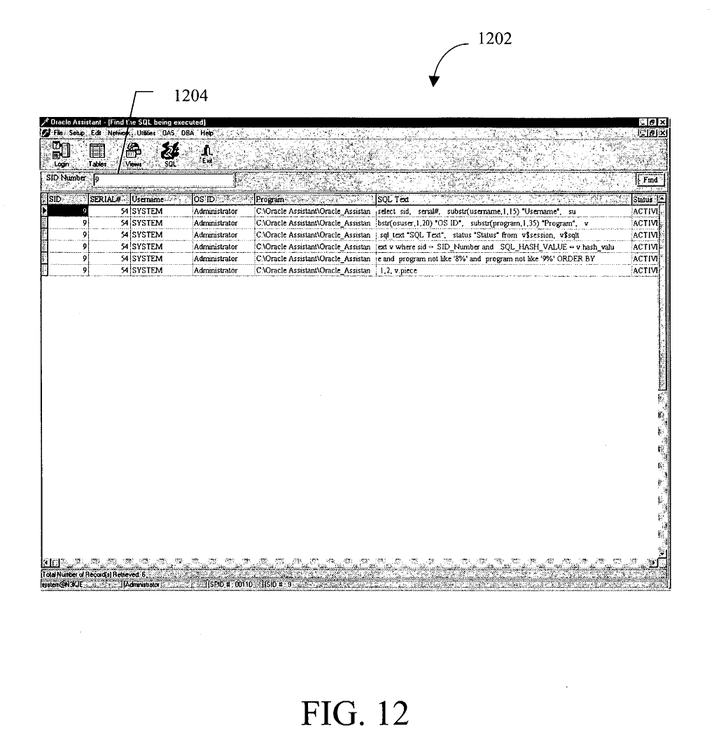

FIG. 12 illustrates the feature provided by the OA 204 when the user 202 selects the SQL Text for a given SID menu option 908. This option allows the user 202 to establish which query is being executed by a given program. This information is invaluable for de-bugging a program. FIG. 12 illustrates the window 1202 which is displayed when the user 202 selects the SQL Text for a given SID menu option 908. The user 202 indicates the desired SID by entering the SID number in the SID Number entry box 1204.

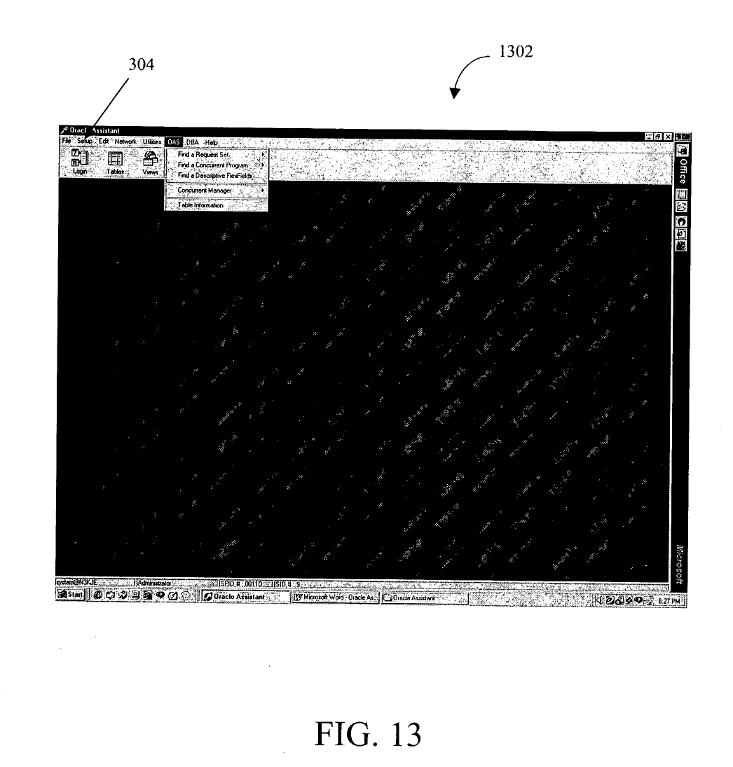

FIG. 13 illustrates the features provided by the OA 204 when the user selects the Oracle Application Suite (OAS) menu option 1302 of the menu 304. The OAS section is specific to an Oracle Financials implementation. OAS and Oracle Financials are well known in the art and will not be described here. The menu options under the OAS section allow the user 202, in read-only mode, to interrogate the database 208 to find out executable specific information. For example, the user 202 may find out answers to the following questions: did a particular program complete successfully the last time it ran; when will the particular program run again; what makes up a particular request set, where a request set is a group of programs which are executed sequentially; and what are the input parameters for a particular program or a particular request set. The menu options in this section safely provide the information to the user 202 about the Application Object Library (AOL). AOL is also well known in the art and will not be described here. Conventionally, the information is not available to users 202 since the information may be easily modified through the AOL. To ensure the integrity of the database, conventional users are not allowed access to the AOL, and thus the above information. However, the OA 204 in accordance with the present invention prevents modification of the database by querying the information in read-only mode. Thus, the user 202 may be given executable specific information above without comprising the security of the database 208.

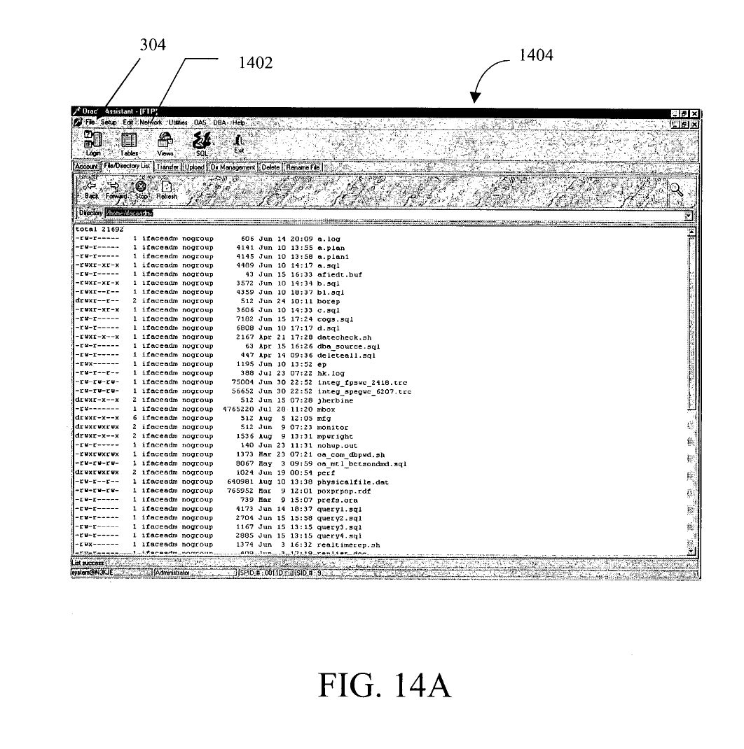

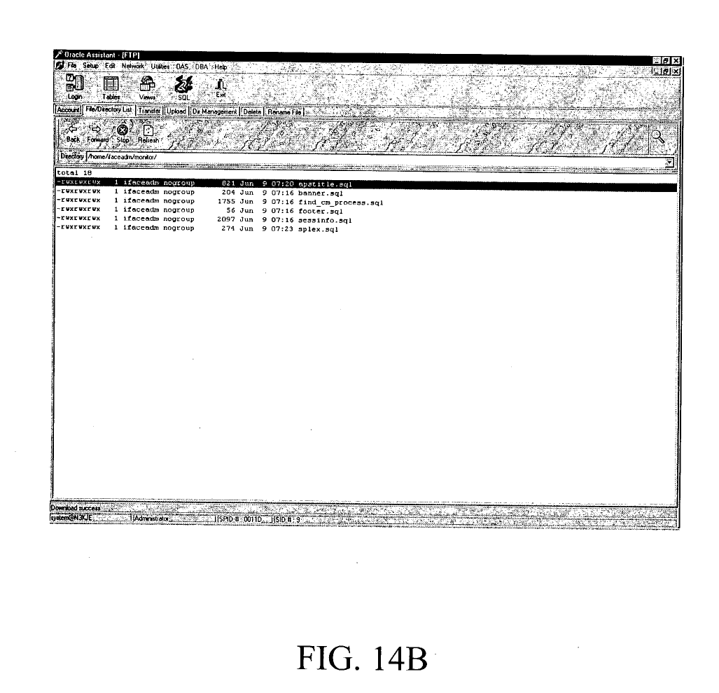

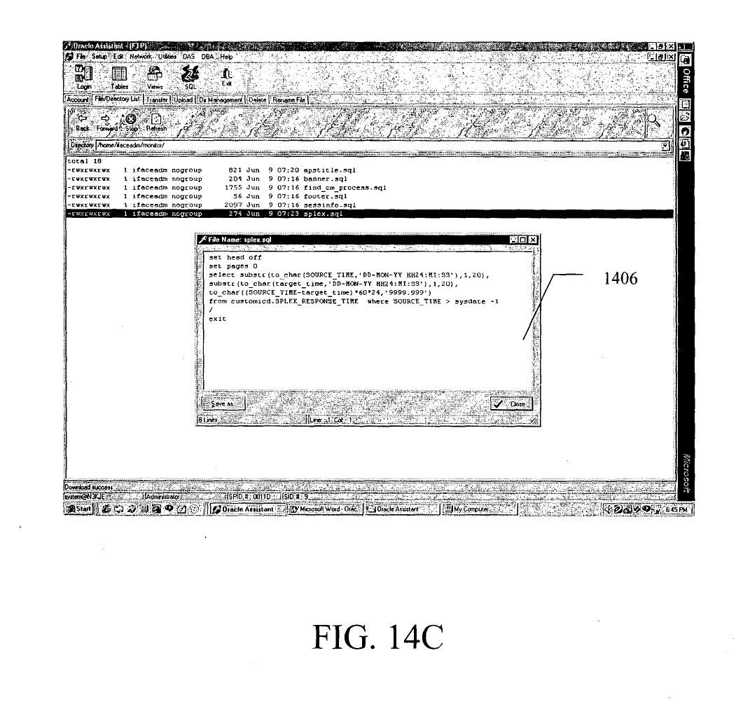

FIGS. 14A-14C illustrates the feature provided by the OA 204 when the user 202 selects the Network menu option 1402 of menu 304. Through selection of the Network menu option 1402, the OA 204 allows the user 202 to interact with a UNIX environment of the workstation 206 by providing a GUI at the front-end. The user 204 may select a FTP menu option (not shown) under the Network menu option 1402. The user 204 then would enter his/her UNIX account information. After being validated by the UNIX operating system, a directory listing would be displayed, as illustrated in window 1404 of FIG. 14A. When the user 204 selects one of the retrieved rows and the selected row is a directory, then the OA 204 would retrieve and display the file listing under that directory, as illustrated in FIG. 14B. When the user 204 selects one of the displayed files, the OA 204 would display the file's contents in a new window 1406, as illustrated in FIG. 14C. The user 204 may also access the UNIX environment directly through a Telnet menu option (not shown) under the Network menu option 1402.

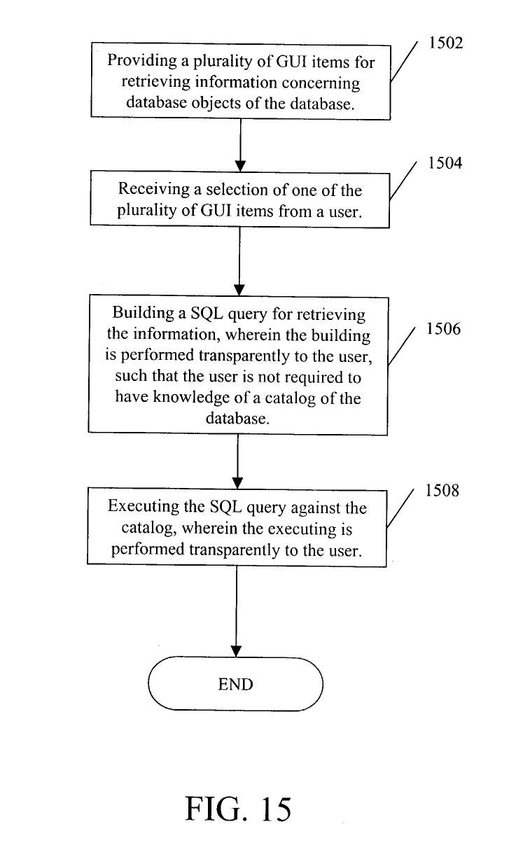

FIG. 15 is a flow chart illustrating a preferred embodiment of a method for providing a graphical interface with databases in accordance with the present invention. First, a plurality of GUI items is provided for retrieving information concerning database objects of the database, via step 1502. Then, a selection of at least one GUI item from a user is received, via step 1504. With the present invention, the user's 202 access of the database 208 is easier since a graphical interface 214 with GUI items is used. A user 202 may retrieve information concerning a variety of database objects by selecting the corresponding GUI items. A SQL query for retrieving the information is then built by the SQL query engine 216, via step 1506, wherein the building is performed transparently to the user, such that the user is not required to have knowledge of the catalog 212 of the database. The SQL query is then executed, via step 1508, against the catalog 212, wherein the executing is performed transparently to the user 202.

Although the present invention is described contacts of Oracle databases, one of ordinary skill in the art will understand that other types databases may be used without departing from the spirit and scope of the present invention.

A method and system for providing a graphical interface to a database has been disclosed. In the preferred embodiment, the graphical interface resides on a workstation and executes in a windows environment. With the graphical interface, the user need not have a thorough understanding of SQL to retrieve information concerning database objects. With the graphical interface, a user can enter as much or as little information concerning a database object as the user knows. The SQL query engine then builds the SQL query or queries required to retrieve the information, and executes the SQL query against the catalog. This is performed transparently to the user. With the graphical interface, a user does not need to enter and re-enter SQL queries manually. By providing a timer feature, the re-execution of SQL queries at time intervals is easier. By automatically storing and retrieving stored queries, access to stored queries is easier. The exporting of query results to different formats is also easier. The graphical interface provides a notification feature which is not available in conventional interfaces. The user can obtain executable specific information in an implementation of Oracle Financial which were not available conventionally, and can retrieve files with the graphical interface performing FTP sessions transparently to the user. The software is flexible enough that the performance of SQL queries by the software may be as easy or as complicated as the user desires. Because the graphical interface executes in a windows environment, common windows features are available, such as cut and paste. The present invention allows a user's interface with a database to be more efficient and less burdensome.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing a graphical interface to a database, comprising the steps of:
(a) providing a plurality of graphical user interface (GUI) items for retrieving information concerning database objects of the database;
(b) receiving a selection of one of the plurality of GUI items from a user;
(c) building a Structured Query Language (SQL) query for retrieving the information, wherein the building is performed transparently to the user, such that the user is not required to have knowledge of a catalog of the database; and
(d) executing the SQL query against the catalog, wherein the executing is performed transparently to the user.

2. The method of claim 1, further comprising:
(e) displaying a result of the executed SQL query.

3. The method of claim 2, wherein the result comprises one or more of the group consisting of:
a result set;
an explain plan; and
a database management system output.

5. The method of claim 1, wherein the providing step (a) comprises:
(a1) providing the plurality of GUI items for building and executing a plurality of corresponding SQL queries for retrieving information concerning a table of the database.

6. The method of claim 1, wherein the providing step (a) comprises:
(a1) providing the plurality of GUI items for building and executing a plurality of corresponding SQL queries for retrieving information concerning a view of the database.

7. The method of claim 1, wherein the providing step (a) comprises:
(a1) providing the plurality of GUI items for scheduling an email notification job.

8. The method of claim 1, wherein the providing step (a) comprises:
(a1) providing the plurality of GUI items corresponding to a plurality of predetermined scripts for retrieving information concerning the database objects.

9. The method of claim 1, wherein the providing step (a) comprises:
(a1) providing the plurality of GUI items for building and executing a plurality of corresponding SQL queries for retrieving statistics for the database.

10. The method of claim 1, wherein the providing step (a) comprises:
(a1) providing the plurality of GUI items for building and executing a plurality of corresponding SQL queries to retrieve a text for a station.

11. The method of claim 10, wherein the executing step (d) comprises:
(d1) receiving an identifier for the station;
(d2) executing the SQL query corresponding to the selected GUI item to retrieve a text for the identified station; and
(d3) displaying the text retrieved by the executed SQL query.

12. The method of claim 1, wherein the providing step (a) comprises:
(a1) providing the plurality of GUI items corresponding to a plurality of SQL queries for retrieving executable specific information in an implementation of Oracle Financial.

13. The method of claim 1, wherein the providing step (a) comprises:
(a1) providing the plurality of GUI items for building and executing a plurality of corresponding SQL queries for retrieving files pertaining to the database.

14. The method of claim 13, wherein the executing step (d) comprises:
(d1) receiving a selection of a file;
(d2) executing the SQL query corresponding to the selected GUI item, wherein the executing comprises performing a file transfer protocol session to retrieve the file; and
(d3) displaying the retrieved file.

15. A system, comprising:
a database comprising a catalog; and
a workstation, comprising a database assistant, the database assistant comprising a user interface and a SQL query engine,
wherein the user interface comprises a plurality of GUI items for retrieving information concerning database objects of the database,
wherein when a selection of one of the plurality of GUI items is received from a user, a SQL query for retrieving the information is built by the SQL query engine transparently to the user such that the user is not required to have knowledge of the catalog,
wherein the SQL query is then executed against the catalog transparently to the user.

16. The system of claim 15, wherein the information comprises at least one of a result set, an explain plan, and a database management system output of the database.

17. The system of claim 15, wherein the information comprises at least one of columns, a context, indexes, and referential constraints of a table of the database.

18. The system of claim 15, wherein the information comprises at least one of columns, a context, and a syntax of a view of the database.

19. The system of claim 15, wherein the information comprises at least one of online users, system event statistics, locks and current system level waits for the database.

20. The system of claim 15, wherein the information comprises at least one of a text for an identified station.

21. The system of claim 15, wherein the graphical interface further comprises means for exporting a result of the SQL query to a desired file format.

22. The system of claim 15, wherein the graphical interface further comprises means for sending an email notification when an execution of the SQL query is successful.

23. The system of claim 15, wherein the graphical interface further comprises means for providing a plurality of predetermined scripts, wherein each script is capable of being assigned an alias.

24. A computer readable medium containing program instructions for providing a graphical interface to a database, the instructions for:
(a) providing a plurality of GUI items for retrieving information concerning database objects of the database;
(b) receiving a selection of one of the plurality of GUI items from a user;
(c) building a SQL query for retrieving the information, wherein the building is performed transparently to the user, such that the user is not required to have knowledge of a catalog of the database; and
(d) executing the SQL query against the catalog, wherein the executing is performed transparently to the user.

25. The medium of claim 24, further comprising instructions for:
(e) displaying a result of the executed SQL query.

26. The medium of claim 25, wherein the result comprises one or more of the group consisting of:
a result set;
an explain plan; and
a database management system output.

27. The medium of claim 24, wherein the providing instruction (a) comprises instructions for:
(a1) providing the plurality of GUI items for building and executing a plurality of corresponding SQL queries for retrieving information concerning a table of the database.

28. The medium of claim 24, wherein the providing instruction (a) comprises instructions for:
(a1) providing the plurality of GUI items for building and executing a plurality of corresponding SQL queries for retrieving information concerning a view of the database.

29. The medium of claim 24, wherein the providing instruction (a) comprises instructions for:
(a1) providing the plurality of GUI items for scheduling an email notification job.

30. The medium of claim 24, wherein the providing instruction (a) comprises instruction for:
(a1) providing the plurality of GUI items corresponding to a plurality of predetermined scripts for retrieving information concerning the database objects.

31. The medium of claim 24, wherein the providing instruction (a) comprises instructions for:
(a1) providing the plurality of GUI items for building and executing a plurality of corresponding SQL queries for retrieving statistics for the database.

32. The medium of claim 24, wherein the providing instruction (a) comprises instructions for:
(a1) providing the plurality of GUI items for building and executing a plurality of corresponding SQL queries to retrieve a text for a station.

33. The medium of claim 32, wherein the executing instruction (d) comprises instructions for:
(d1) receiving an identifier for the station;
(d2) executing the SQL query corresponding to the selected GUI item to retrieve a text for the identified station; and
(d3) displaying the text retrieved by the executed SQL query.

34. The medium of claim 24, wherein the providing instruction (a) comprises instructions for:
(a1) providing the plurality of GUI items corresponding to a plurality of SQL queries for retrieving executable specific information in an implementation of Oracle Financial.

35. The medium of claim 24, wherein the providing instruction (a) comprises instructions for:
(a1) providing the plurality of GUI items for building and executing a plurality of corresponding SQL queries for retrieving files pertaining to the database.

36. The medium of claim 35, wherein the executing instruction (d) comprises instructions for:
(d1) receiving a selection of a file;
(d2) executing the SQL query corresponding to the selected GUI item, wherein the executing comprises performing a file transfer protocol session to retrieve the file; and
(d3) displaying the retrieved file.
